(19) United States
(12) Patent Application Publication
(10) Pub. No.: US 2025/0145075 A1
(43) Pub. Date: May 8, 2025

(54) REMOVEABLE AWNING FOR A RECREATIONAL VEHICLE

(71) Applicant: James P. Kostansek, Nashua, NH (US)

(72) Inventor: James P. Kostansek, Nashua, NH (US)

(21) Appl. No.: 18/931,614

(22) Filed: Oct. 30, 2024

Related U.S. Application Data
(60) Provisional application No. 63/596,378, filed on Nov. 6, 2023.

(51) Int. Cl. B60P 3/34; B60J 1/20; B60J 5/04; E04H 15/08

(52) U.S. Cl. CPC B60P 3/343; E04H 15/08; B60J 1/2011; B60J 5/0494

(57) ABSTRACT

An awning system for a recreational vehicle (RV) includes a bowed flexible panel inserted between upper and lower rails mounted above an RV door or window. An upper edge of an awning panel is inserted between the flexible panel and the upper rail, and rests on the flexible panel, extending outward at an oblique angle, which can be adjusted by a spacer. The awning panel upper edge can include a retention bead cooperative with a J-shaped upper rail to enhance panel retention. The awning panel can include upper and lower segments joined by a hinge and maintained in alignment by a hinge return spring, and by panel stops that prevent over-rotation about the hinge. Extended length rails can enable offset mounting of awning panels and/or mounting of extended width awning panels. Shade panes can extend downward from the front and/or side edges of the awning panel.

### RELATED APPLICATIONS

This application claims the benefit of U.S. Provisional Application No. 63/596,378, filed Nov. 6, 2023, which is herein incorporated by reference in its entirety for all purposes.

### FIELD OF THE INVENTION

The invention relates to accessories for recreational vehicles, and more particularly, to awnings for recreational vehicles.

### BACKGROUND OF THE INVENTION

Recreational vehicles, also referred to herein simply as RVs, are motor vehicles or trailers (both referred to herein generically as vehicles) that include living quarters designed for accommodation upon arrival at an outdoor destination, such as a campsite. As such, RVs are required to function efficiently as vehicles during transit, while also providing as much comfort and convenience as possible when stationary and being used as accommodations.

Providing the comforts of a large home in a smaller mobile package comes with many challenges. Storage space and weight are key items that every RV owner must balance when considering what to include in an RV, and each item that is added must be considered against the available payload capacity, so that the vehicle's gross vehicle weight rating is not exceeded, and fuel consumption is not unduly affected. Products that add minimal weight and can be easily stored are therefore highly desired, while it is less desirable to include items that are heavy and/or awkwardly shaped, and difficult to store. Other factors that must be considered in RV design include aerodynamics, maintainability, reliability, road worthiness, and fuel economy.

With reference to FIG. 1A, nearly all RVs 100 include windows 102 along their sides, front, and/or rear that enable light to enter the interior of the RV 100, while also allowing occupants to view the surrounding outdoor environment. Typically, such windows 102 are sliding windows 102 that can be opened to ventilate the interior of the RV 100 during warm weather. RV's also typically include at least one door 114 or other entry into the interior, which may include a screen that allows it to be left open when camping for added light and ventilation within the interior. However, it can be necessary, even during a light rain, for the windows 102 and doors 114 to remain closed even if the interior is uncomfortably warm, to prevent rain from entering the RV 100.

It will be understood that, unless otherwise stated or required by context, the term “window” 102 is used herein to refer generically to any portal that can be opened to allow air to enter the interior of an RV, including doors 114, even if the word “door” or the item number 114 does not appear.

One approach is to provide an air conditioning apparatus as an accessory to the RV so that the interior can remain cool while the windows 102 are closed. However, an air conditioner typically reduces the aerodynamics of the RV, adds considerable weight to the RV, and also consumes large amounts of energy. Furthermore, an air conditioner creates an “artificial” atmosphere within an RV, which is contrary to the desires of many users to experience a “natural” environment as much as possible.

If an RV window 102 is to remain open while it is raining, a reliable means must be provided to keep the rain out. There are two sources of water that must be diverted from the opening. The first is “runoff water,” i.e. the water running down the walls of the RV onto the window frame. Water running down the walls may have originated on the roof of the RV, or may be a result of rain striking the wall and running down 102. The second source of water is airborne water/rain that can directly enter the window opening.

One approach to dealing with the water running down the walls 106 of the RV 100 is to install rain gutters 104 over the windows 102 to catch and divert the water. Rain gutters 104 are “narrow,” i.e. they do not extend very far outward from the walls 106 of the RV 100, and as a result there is almost no effect on the aerodynamics of the RV 100 while traveling.

While rain gutters 104 can certainly be advantageous, rain gutters 104 alone provide only part of the solution. This is because, while rain gutters 104 are very effective at diverting rain running down the walls 106 of the RV, the narrow rain gutters 104 are only effective against airborne rain when the rain is either falling straight down, or is directed away from the window 102. Even a slight air turbulence or breeze toward the window 102 can allow airborne rain to enter directly through the window opening. Even in the case where the rain is falling straight down, the walls 106 of the RV may be tapered, being narrower at the top than the bottom, so that the bottom of the window 102 protrudes further out than the top, thereby allowing some rain to enter.

With reference to FIG. 1B, one approach that attempts to exclude both runoff and airborne water is to deploy an awning window 112 (as opposed to a sliding window 102 (FIG. 1B)). Awning windows 112 are effective, streamlined, and typically do not require separate rain gutters 104. However, awning windows 112 are expensive, and are not a realistic option to upgrade an existing RV that includes sliding windows 102. Also, awning windows 112 are typically sized to fit the window, and do not provide protection against airborne rain that may fall in a slanted direction due to a breeze.

With reference to FIG. 1C, an existing RV with a sliding window 102 can be upgraded to include a separate awning 106 that is installed over the sliding RV window 102. Awnings 106 can be effective in blocking airborne rain, and have the added advantage that they can be substantially opaque, thereby deflecting sunlight and reducing solar heating of the RV interior, while improving the view from the window 102 when the window 102 is facing the sun. A separate awning 106 is often deployed in combination with a rain gutter 104 to ensure that rain water running down the wall of the RV 100 is diverted away from the window 102, as well preventing airborne rain from directly entering the window. A canopy (not shown) mounted above the window 202 and supported by poles from the ground can be used in place of an awning 106.

However, awnings 106 require significant mechanical competence to support their weight. Accordingly, they typically include metal frames 108 and support struts 110 that are expensive and heavy, and must be firmly and rigidly attached to the RV 100. The struts 110, in particular, can be subject to wear and eventual failure. Separate awnings 106 can be permanent or temporary, but so-called “temporary” awnings 106 typically require considerable time and effort for a user to install and remove. They also tend to be more susceptible to wind damage. Furthermore, a temporary awning 106 that a user leaves in place because it is too much trouble to remove, reduces the aerodynamics of the RV 100. And if a deployed awning is subjected to an unexpected strong gust of wind, it may be damaged, and may even damage the side of the RV where it is attached.

Permanent vehicle awnings, as well as removable awnings, are usually deployed on a single side of a vehicle, typically over a doorway or other entry point. As a result, it may not be possible to open windows installed on other walls of the RV when it is raining, thereby limiting the ability to maximize the flow of fresh air through the vehicle as cross ventilation.

Furthermore, because awning systems typically cover only a single side of a vehicle, when orienting an RV at a campsite, the RV owner must consider the orientation of the RV relative to the sun, the direction of the wind and rain, along with many other factors, such as the suitability and levelness of the parking space, the view, the location of trees and structures. Often, the most favorable orientation of the RV that would minimize rain entry or provide optimal shade is not achievable due to limited parking space and obstacles located in the vicinity. In some cases, it may not be possible, or worth the effort, or risk, to deploy large awnings.

Permanently mounted vehicle awning systems are typically placed high above the ground so that they don't impede foot traffic, and provide head room. As the sun moves across the sky the portion of the RV in shade changes. Some permanently mounted vehicle awnings provide an ability to tilt the awning down to continue to provide shade in these situations.

While removable canopies may be repositioned to provide shade in desired areas, it is typically a time-consuming process, especially if the canopy has been staked to the ground. Also, canopies are typically fabric or canvas structures, which must be fully dried to prevent molding after becoming wet due to rain exposure. Simply toweling or wiping the canopy is not sufficient. Instead, the canopy must remain deployed during dry weather until it is fully air-dried. This can be an inconvenient requirement, for example if the user wishes to change locations, or store the RV, shortly after the rain has ceased. Furthermore, any debris that falls onto the canopy while it is deployed, such as sticks, leaves, etc., must be removed before the canopy can be retracted and stowed. The debris can be difficult to see, and can require the use of long poles or brooms, which can only be applied with limited force without dislodging the canopy from its support system. Also, washing the canopy requires special detergents that are specially designed for cleaning canvas and other fabrics.

Users often seek to upgrade and customize their RVs, and often prefer to reduce the cost by doing the work themselves. For example, an RV owner who wishes to open his RV windows when it rains may wish to add a rain gutter and/or awning to their RV. Rain gutters can often be applied over RV windows using an adhesive, thereby rendering the rain gutter easy for a typical user to install, and minimizing, or eliminating, any impact on the exterior wall of the RV. To be effective the gutter needs to be paired with an awning system. However, permanent vehicle awning systems generally require professional installation, and permanent modification of the walls of the RV, while canopy systems may require the installation of anchors high on the vehicle, are more time consuming to deploy and generally more difficult to store due to their bulk.

What is needed, therefore, is an RV window awning system upgrade, and method of use thereof, that is capable of effectively diverting rain and providing window shade to windows on all sides of an RV, regardless of how the vehicle is oriented and what surrounds it, where the upgrade is low in cost, simple to install, light-weight, easily deployed, easily removed and stored, has minimal impact on the walls of an RV, remains undamaged and will not damage an RV if subjected to very strong wind, is easy to clean and maintain, can be easily wiped dry after exposure to rain, and minimizes any impact to the aerodynamics of the RV during travel.

### SUMMARY OF THE INVENTION

The present invention is an RV window awning system upgrade, and method of use thereof, that is capable of effectively diverting rain and providing window shade to windows on all sides of an RV, regardless of how the vehicle is oriented and what surrounds it, where the upgrade is low in cost, simple to install, light-weight, easily deployed, easily removed and stored, has minimal impact on the walls of an RV, remains undamaged and will not damage an RV if subjected to very strong wind, is easy to clean and maintain, can be easily wiped dry after exposure to rain, and minimizes any impact to the aerodynamics of the RV during travel.

According to the present invention, a spaced-apart pair of opposing rails or tracks extend above a window of an RV. Each of the rails comprises a horizontal section that extends away from the side wall of the RV. The rails are light in weight, and can be made, for example, from thin-wall aluminum, or from a rigid or semi-rigid plastic. In embodiments, attachment of the rails to the RV is by an adhesive, which can be implemented by many RV users without professional help. The horizontal sections of the rails extend only modestly outward from the RV wall, such as between ½ inch and 2 inches, thereby minimizing any impact on the aerodynamics of the RV. In embodiments, the horizontal sections of the rails terminate in horizontal edges, such that the rails are “L” shaped. In other embodiments, the horizontal sections of the rails are terminated by inward extending lips, such that the rails are “J” shaped. In certain embodiments, the rails are combined into a channel having a rear surface fixed to the RV.

The present invention further includes a normally flat, elastic flexible panel having a width that is greater than the spaced-apart distance between the rails. The flexible panel can be installed between the rails by flexing the upper and lower edges of the flexible panel toward each other, thereby forming the flexible panel into a curved shape, and inserting the upper and lower edges of the flexible panel between the rails, whereupon the upper and lower edges of the flexible panel are pressed outward against the rails, simultaneously maintaining the curved shape of the flexible panel while retaining the flexible panel between the rails, and in embodiments also due to an inward overhang that is provided by “J” shaped rails. In embodiments, the flexible panel is a plastic panel.

The disclosed invention also includes a flat, rigid or semi-rigid awning panel, which can be a plastic panel or a panel of plastic-fluted, corrugated cardboard. In embodiments, an upper edge of the awning panel can be inserted between the upper edge of the flexible panel and the upper rail, so that it is pressed against the upper rail. In embodiments, the awning panel is held in place entirely by friction, while in other embodiments that include “J” shaped rails, retention of the awning panel is enhanced by providing a retention bead along the upper edge of the panel. The awning panel is thereby caused to extend outward from the upper rail, and to rest against the curve of the flexible panel, so that it extends at an oblique angle away from the wall of the RV and in front of the window, thereby serving as an awning. The flexible panel thereby functions as a bow spring that enables the awning panel to respond flexibly to gusts of wind and/or to impinging rain. In similar embodiments, the flexible panel and the awning panel are fixed to each other at their upper edges.

The flexible panel and awning panel can be quickly and easily installed on the RV According to one approach, the upper edge of the awning panel is held up against the bottom edge of the top rail and pushed lightly into the rail so that the entire upper edge of the awning panel is in contact with the vertical section of the rail If the awning panel includes a retention bead the bead will be positioned behind the lip of the rail Next the flexible panel is bowed by hand. The top edge of the flexible panel is installed first. The lower edge of the flexible panel is then worked into the bottom rail in a manner that maintains tension on its upper edge, while keeping the awning panel in place until the bottom edge of the flexible panel has been installed into the lower rail

The flexible panel and the awning panel can also be easily and quickly removed from between the rails. If a retention bead is not included on the awning panel, both of the panels can simply be pulled away from the RV. If a retention bead is included on the awning panel, removal of the awning panel can require a slight compression of the flexible panel. Once the awning panel has been removed, the flexible panel can then be easily pulled away from the RV. Having been removed, the panels revert to their naturally flat shapes. The two flat panels can then be easily stored in a convenient location within the RV. Accordingly, only the rails remain mounted to the RV when it is traveling. If, during use, the disclosed awning is subjected to a strong wind, the awning panel and possibly the flexible panel will simply be dislodged from between the rails, and will fall to the ground for later retrieval, without damage to the RV, and typically without damage to the panels.

In embodiments, the rails and flexible panel extend significantly beyond the window in one or both dimensions, such that sunlight impinging on the RV from an angle can be blocked by offsetting the awning panel above the window, installing an awning panel that is much wider than the window, or installing a plurality of awning panels side-by-side above the window.

In various embodiments one or more accessories are applied to the awning panel, such as decorative graphics, solar panels, and/or rechargeable puck lighting fixtures.

In embodiments the awning panel is split into upper and lower panel segments that are connected together by one or more hinges, which can be conventional hinge-pin hinges or living hinges. In embodiments, a living hinge joining the two panel segments is formed by a strip of adhesive tape, such as “duct” tape. This arrangement enables the lower panel segment, which includes a majority of the awning panel, to pivot upward about the hinge or hinges when subjected to an updraft, for example caused by wind impinging on the side of the RV below the awning panel. By allowing most of the awning panel to rotate upward, the upper panel segment maintains its orientation, such that the upper edge of the upper panel segment is not levered away from the flexible panel and the upper rail, and such that rain descending vertically along or adjacent to the side of the RV is deflected away from the window.

In some of these embodiments, the awning panel segments are made from a light, relatively thick sheet, such as from plastic-fluted, corrugated cardboard, so that the thickness of the panel segments causes their adjoining edges to abut against each other, and prevents the lower panel segment from hyperextending, i.e. pivoting downward beyond alignment with the upper panel segment. Abutting panel stops can be attached to the lower sides of the panel segments if the panel material is insufficiently thick and/or rigid to prevent hyperextending of the lower panel segment.

Some of these embodiments include a hinge return spring, which can be a conventional coil spring or a cantilever spring. the hinge return spring causes the lower panel segment to return to its extended position after being lifted up by a gust of wind. In some embodiments that include a cantilever spring, one end of the cantilever spring is attached to the upper panel segment, for example by an adhesive, while the other end of the cantilever spring either rests against the lower panel segment, or extends through a sleeve provided in the lower panel segment that allows the cantilever spring to extend toward the lower panel segment when the cantilever spring is being flexed.

A first general aspect of the present invention is an awning system for a recreational vehicle (RV). The awning comprises an upper rail and a lower rail, each of the upper and lower rails being configured for horizontal mounting thereof to an exterior, substantially vertical wall of the RV, each of the upper and lower rails comprising, in cross section, a vertical section configured for mounting against the vertical wall of the RV, and a horizontal section configured for extending out substantially horizontally from the vertical section away from the vertical wall of the RV, the upper and lower rails being mountable above a window or door of the RV with the upper rail being above the lower rail in a vertically aligned configuration in which the horizontal sections are vertically separated from each other by a rail separating gap, a substantially rectangular, flat, flexible panel having upper and lower edges separated by a flexible panel width that is greater than the rail-separating gap, the flexible panel being bendable about a longitudinal axis thereof, thereby forming a curved flexible panel, the upper and lower edges of the curved flexible panel being insertable between the horizontal sections of the upper and lower rails, so that a central portion of the curved flexible panel extends outward from the vertical wall of the RV, elasticity of the curved flexible panel causing the upper and lower edges of the curved flexible panel to press outwardly against the horizontal sections of the upper and lower rails, and an awning panel having an upper awning edge that can be positioned between the horizontal section of the upper rail and the upper edge of the curved flexible panel, thereby fixing the upper awning edge proximate the vertical wall of the RV while a remainder of the awning panel extends away from the vertical wall of the RV at an oblique angle above the window or door, and is supported by the curved central portion of the flexible panel.

In embodiments, the awning system is configured for fixing of the upper awning edge proximate the vertical wall of the RV due entirely to friction between the flexible panel, the awning panel, and the upper rail.

In any of the above embodiments, the upper rail can include a lip section that extends vertically downward from a distal edge of the horizontal section that is furthest from the vertical wall of the RV, the upper rail thereby having a “J” shape in cross section. In some of these embodiments, the awning panel further comprises a retention bead extending horizontally proximate the upper awning edge and configured for enhancing the fixing of the upper awning edge proximate the vertical wall of the RV due to contact between the retention bead and the lip section of the upper rail.5. The awning system of claim 1, further comprising a spacer configured for insertion between the flexible panel and the awning panel proximate the upper rail, thereby adjusting the oblique angle of the awning panel.

In any of the above embodiments, the awning panel can include an upper panel segment and a lower panel segment, the upper and lower panel segments being joined together by an awning hinge that is configured to allow the lower panel segment to pivot upward about the awning hinge while the upper panel segment remains fixed at the oblique angle proximate the vertical wall of the RV. In some of these embodiments, the awning hinge is a living hinge. Any of these embodiments can further include a hinge return spring cooperative with the awning hinge and configured to return the lower panel segment into alignment with the upper panel segment. In some of these embodiments the awning hinge is a living hinge, and wherein the hinge return spring is a cantilever spring having an upper end fixed to the upper panel segment, and a lower end configured to press against the lower panel segment when the lower panel segment is pivoted upward about the awning hinge. And in some of these embodiments, the lower end of the cantilever spring extends through a sleeve that is fixed to the lower panel segment.

Any of the above embodiments in which the awning panel includes an upper panel segment and a lower panel segment, the upper and lower panel segments being joined together by an awning hinge that is configured to allow the lower panel segment to pivot upward about the awning hinge while the upper panel segment remains fixed at the oblique angle proximate the vertical wall of the RV, can further comprise upper and lower panel stops affixed respectively to lower sides of the upper and lower panel segments and substantially aligned with abutting edges thereof, the upper and lower panel stops being thereby configured to inhibit rotation of the lower panel segment downwardly out of alignment with the upper panel segment.

Any of the above embodiments can further include a third rail configured for horizontal mounting thereof to the vertical wall of the RV below the window or door of the RV, the third rail comprising, in cross section, a vertical section configured for mounting against the vertical wall of the RV and a horizontal section configured for extending out substantially horizontally from the vertical section away from the vertical wall of the RV, and a covering panel having upper and lower covering edges that can be installed between one of the upper and lower rails and the third rails such that the covering panel is flexed and bows distally away from the vertical wall of the RV, thereby causing the covering panel to cover the window or door of the RV. In some of these embodiments, the covering panel is tinted or opaque, thereby reducing or preventing penetration therethrough of at least one of visible light and ultra-violet light.

Any of the above embodiments can further include at least one of a decorative graphic, a solar panel, and a lighting fixture applied to the awning panel.

Any of the above embodiments can further include at least one shade panel attached to and extending vertically down from a front edge or a side edge of the awning panel.

In any of the above embodiments, the upper and lower rails can extend laterally beyond at least one side of the window or door of the RV, thereby enabling the awning panel to be wider than the window or door of the RV, and/or to be suspended in a location that is not vertically aligned with the window or door of the RV.

A second general aspect of the present invention is a method of shielding a window or door provided in a substantially vertical wall of a recreational vehicle (RV) from at least one of sunlight and rain. The method includes providing an awning system according to the first general aspect, mounting the upper and lower rails above the window or door of the RV with the upper rail being above the lower rail in the vertically aligned configuration in which the horizontal sections are vertically separated from each other by the rail separating gap, bending the flat, flexible panel about its longitudinal axis, thereby forming it as a curved flexible panel, inserting the upper and lower edges of the flexible panel between the horizontal sections of the upper and lower rails, a central portion of the curved flexible panel extending outward from the vertical wall of the RV, so that the elasticity of the curved flexible panel causes the upper and lower edges of the curved flexible panel to press outwardly against the horizontal sections of the upper and lower rails, thereby maintaining the upper and lower edges of the curved flexible panel proximate the vertical wall of the RV, and positioning the upper awning edge between the horizontal section of the upper rail and the upper edge of the curved flexible panel, thereby fixing the upper awning edge proximate the wall of the RV while a remainder of the awning panel extends away from the wall of the RV and is supported by the curved central portion of the curved flexible panel, such that the awning panel extends at the oblique angle away from the RV over the window or door.

In embodiments, mounting the upper and lower rails above the window or door of the RV includes forming a watertight seal between the upper rail and the vertical wall of the RV.

In any of the above embodiments, the awning system can further include a spacer and wherein the method further includes inserting the spacer between the awning panel and the flexible panel proximate the upper rail, thereby adjusting the oblique angle of the awning panel.

And in any of the above embodiments, the method can further include detaching both the curved flexible panel and the awning panel from the vertical wall of the RV, whereupon both the curved flexible panel and the awning panel return naturally to a substantially flat configuration.

The features and advantages described herein are not all-inclusive and, in particular, many additional features and advantages will be apparent to one of ordinary skill in the art in view of the drawings, specification, and claims. Moreover, it should be noted that the language used in the specification has been principally selected for readability and instructional purposes, and not to limit the scope of the inventive subject matter.

### BRIEF DESCRIPTION OF THE DRAWINGS

FIG. 1A is a perspective view of a recreational vehicle (RV) of the prior art that includes a rain gutter and a sliding window;

FIG. 1B is a perspective view of a recreational vehicle (RV) of the prior art that includes an awning window;

FIG. 1C is a perspective view of a recreational vehicle (RV) of the prior art that includes a separate window awning installed above a window;

FIG. 2A is a front view of separate upper and lower rails according to an embodiment of the present invention;

FIG. 2B is a front view of a channel that incorporates the upper and lower rails in an embodiment of the present invention;

FIG. 2C is a front view of a flexible panel in its flat configuration according to an embodiment of the present invention;

FIG. 2D is a front view of an awning panel in its flat configuration according to an embodiment of the present invention;

FIG. 3A is side view of the flexible panel of FIG. 2C and the awning panel of FIG. 2D installed between the rails of FIG. 2A according to an embodiment of the present invention;

FIG. 3B is a side view showing the flexible panel of FIG. 2C and the awning panel of FIG. 2D installed between the rails of FIG. 2B, the oblique angle of the awning panel being adjusted by a spacer, according to an embodiment of the present invention;

FIG. 3C is a side view showing a flexible panel and an awning panel installed between the rails of FIG. 2B, where the flexible panel and the awning panel were formed by bending a single sheet of material, according to an embodiment of the present invention;

FIG. 4A is a side view of an embodiment that is similar to FIGS. 3A and 3B, wherein the upper edge of the awning panel is retained entirely due to friction;

FIG. 4B is a side view of the embodiment of FIG. 4A shown when a downward force is applied to the awning panel, showing the function of the flexible panel as a bow spring;

FIG. 4C is a front view of an embodiment similar to FIG. 3A in which the rails and flexible panel extends beyond both sides of the window and the awning panel is offset from the window to block sunlight that is incident on the window from an angle;

FIG. 4D is a front view of an embodiment similar to FIG. 4C, in which the awning panel is significantly wider than the window, thereby blocking sunlight that is incident on the window from an angle;

FIG. 4E is a front view of an embodiment similar to FIG. 4C, in which two awning panels are installed side-by-side above the window, thereby blocking sunlight that is incident on the window from an angle;

FIG. 4F is a perspective front view of an embodiment in which a lightweight shade panel is suspended from the front of the awning panel;

FIG. 4G is a perspective front view of an embodiment similar to FIG. 4F, but in which lightweight shade panels are suspended from the front and from both sides of the awning panel;

FIG. 5A is a side view of an embodiment similar to FIG. 3A, in which the upper edge of the awning panel includes a retention bead configured to enhance retention of the upper edge by the upper rail;

FIG. 5B is a side view of an embodiment similar to FIG. 3B, in which the upper edge of the awning panel includes a retention bead configured to enhance retention of the upper edge by the upper rail;

FIG. 6A is a side view of an embodiment in which the awning panel comprises upper and lower panel segments that are joined by a hinge pin hinge, shown with the upper and lower panel segments aligned;

FIG. 6B is a side view of the embodiment of FIG. 6A, shown with the lower panel segment pivoted upward about the hinge;

FIG. 6C is a side view of an embodiment in which the awning panel comprises upper and lower panel segments that are joined by a living hinge, shown with the lower panel segment pivoted upward about the living hinge;

FIG. 7A is a side view of an embodiment similar to FIG. 6C but further including a hinge return spring that is a cantilever spring, shown with the lower panel segment pivoted upward about the living hinge;

FIG. 7B is a side view of the embodiment of FIG. 7A, shown with the upper and lower panel segments aligned;

FIG. 8A is a side view of an embodiment similar to FIG. 7B, but further including a spring mount provided on the upper panel segment and configured to retain the upper end of the cantilever spring, and a sleeve provided on the lower panel segment through which the lower end of the cantilever spring extends, shown with the upper and lower panel segments aligned;

FIG. 8B is a side view of the embodiment of FIG. 8A, shown with the lower panel segment pivoted upward about the living hinge;

FIG. 9A is a perspective view of an RV having an awning system similar to FIG. 3A installed thereon, wherein a decorative graphic and a solar panel are applied to the awning panel, according to an embodiment of the present invention;

FIG. 9B is a perspective view of an RV having the awning system similar to FIG. 8A installed thereon, wherein the upper panel segment includes a plurality of puck lights installed therein, according to an embodiment of the present invention;

FIG. 10A is a perspective view of an RV to which upper and lower rails and a third rail have been applied according to an embodiment of the present invention, the embodiment being shown with neither the flexible panel nor the awning panel installed between the upper and lower rails, and with a cover panel being installed between the upper rail and the third rail; and

FIG. 10B is a perspective view of the embodiment of FIG. 10A shown in a traveling configuration with all panels removed from the upper, lower, and third rails.

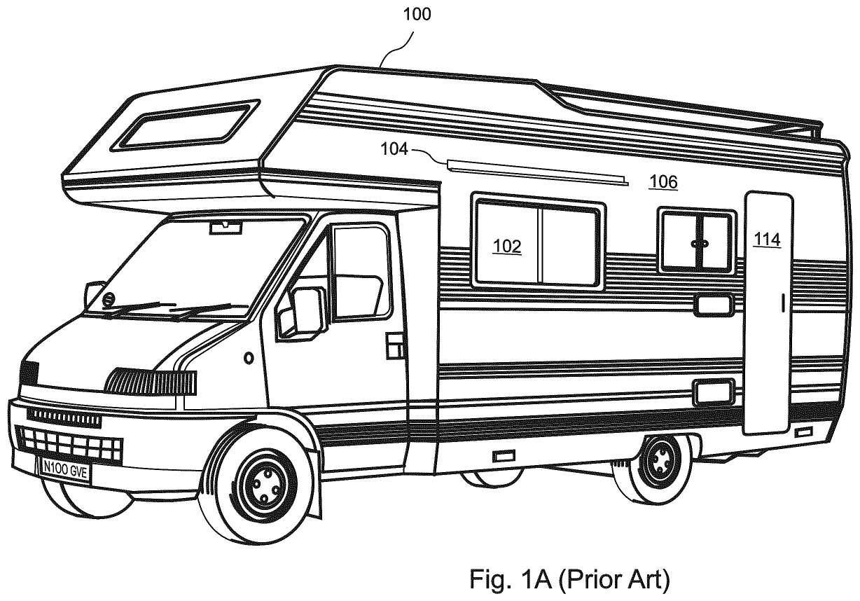

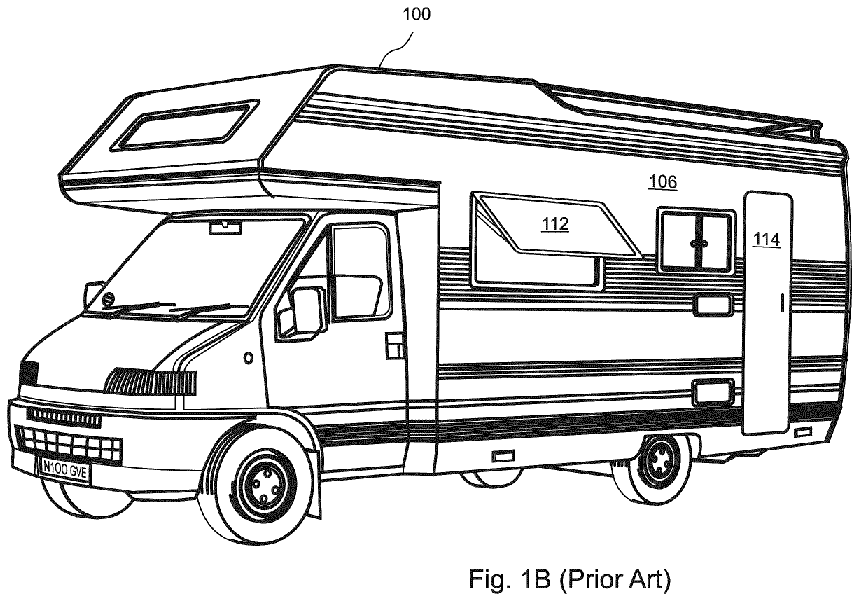

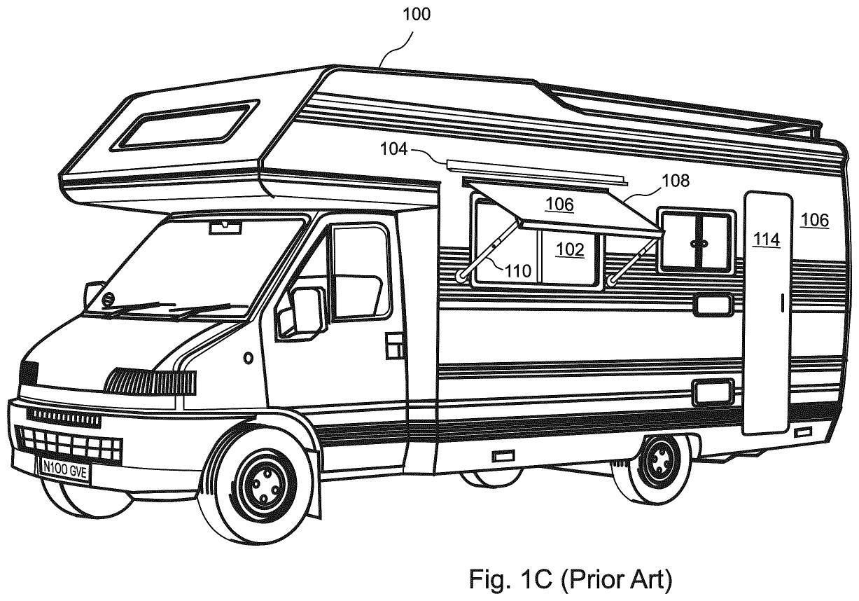

### DETAILED DESCRIPTION

The present invention is an RV window awning system upgrade, and method of use thereof, that is capable of effectively diverting rain and providing window shade to windows on all sides of an RV, regardless of how the vehicle is oriented and what surrounds it, where the upgrade is low in cost, simple to install, light-weight, easily deployed, easily removed and stored, has minimal impact on the walls of an RV, remains undamaged and will not damage an RV if subjected to very strong wind, is easy to clean and maintain, can be easily wiped dry after exposure to rain, and minimizes any impact to the aerodynamics of the RV during travel.

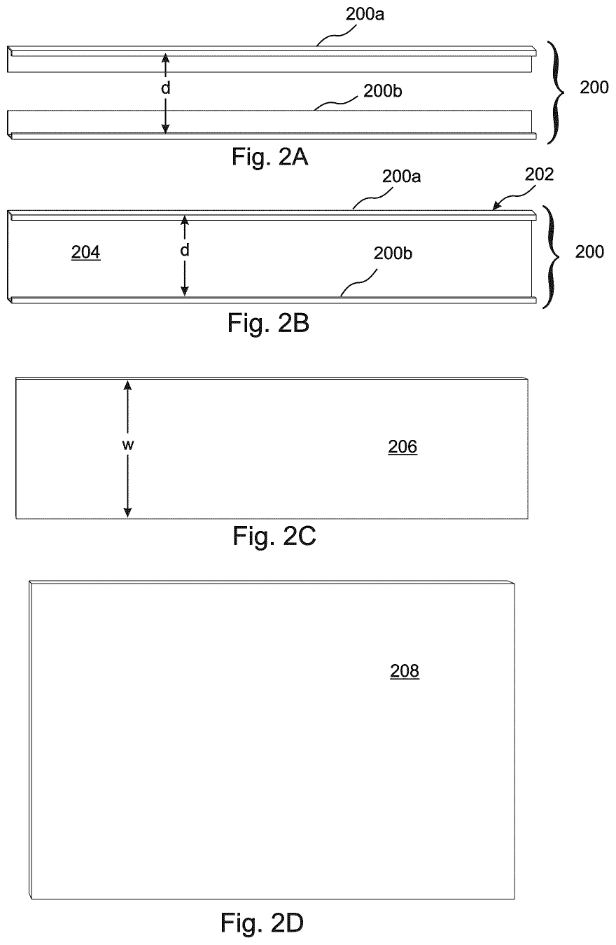

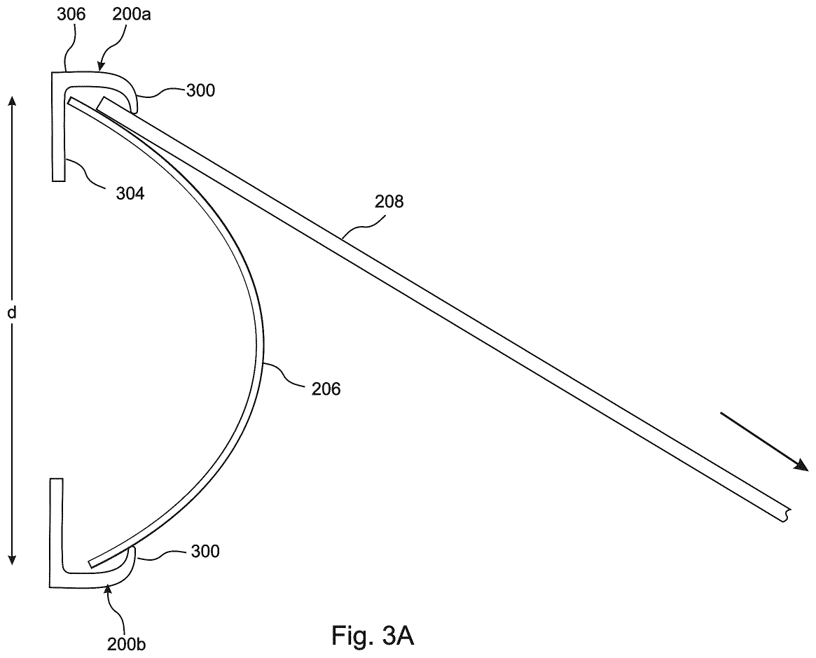

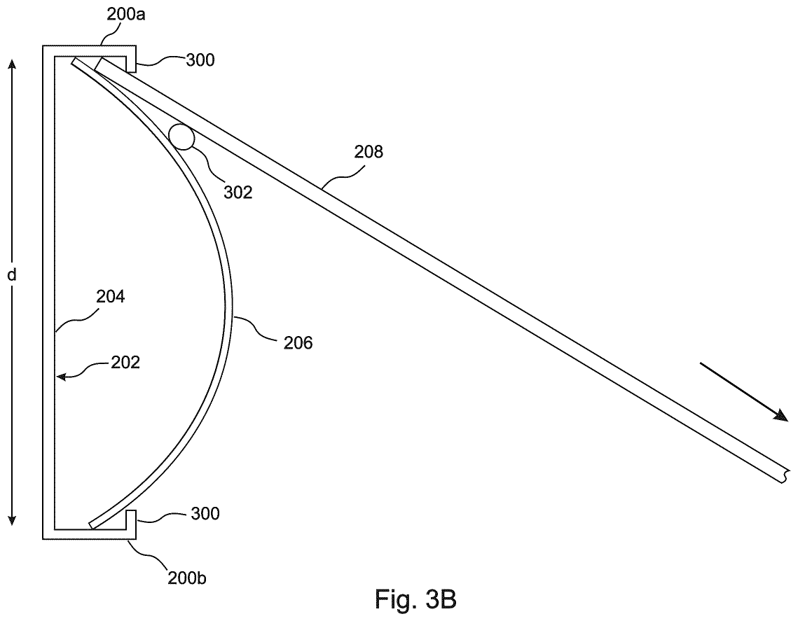

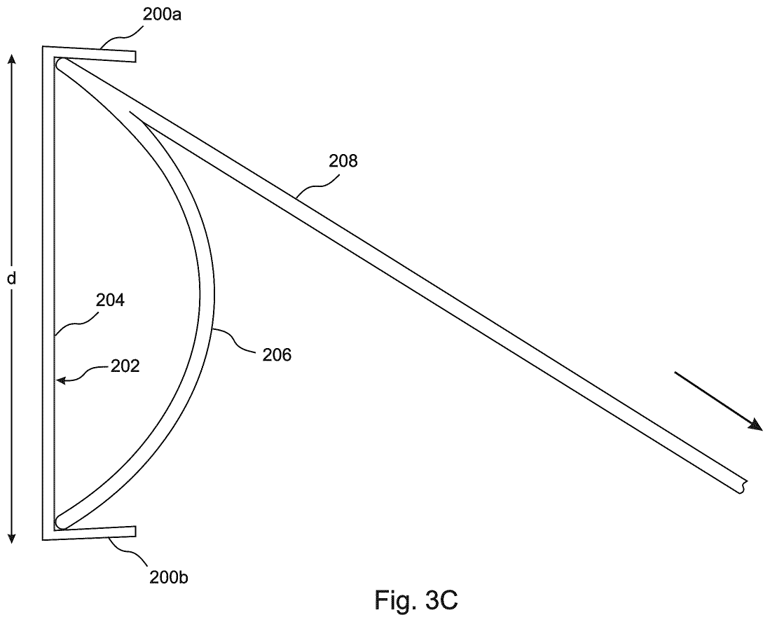

With reference to FIGS. 2A through 3A, the invention includes a pair of opposing rails or tracks 200, each of which includes a vertical section 304 that can be mounted to the exterior wall of the RV, and a “horizontal” section 306 that extends outward from the vertical section 304. It will be noted that, in the embodiment of FIG. 3A, the “horizontal” section 306 is curved, while in the embodiment of FIG. 2A it is perpendicular to the vertical section 304.

When they are mounted to the RV, the rails 200 extend horizontally above a window of the RV and are vertically aligned with each other, the horizontal sections 304 being spaced apart by a rail-separating gap “d.” The rails 200 are light in weight, and can be made, for example, from thin-wall aluminum, or from a rigid or semi-rigid plastic.

In other embodiments, the rails 200 are pliable and somewhat elastomeric, thereby allowing them to conform to, and form a watertight seal with, a curved RV wall surface, as well as providing enhanced compressional and/or frictional retention of the panels 206, 208 as described below. In the embodiment of FIG. 3A, a pair of conventional rain gutters 104 is used as the rails, with one of the rain gutters 104 inverted to form the upper rail 200a.

In embodiments, attachment of the rails 200 to the RV 100 is by an adhesive, which can be implemented by many RV users without professional help. The rails 200 extend only modestly outward from the RV wall, such as between ½ inch and 2 inches, thereby minimizing any impact on the aerodynamics of the RV 100. In the illustrated embodiments, the rails 200 are “J” shaped, in that each rail has a small “lip” 300 that extends from the outer edge of the horizontal section 306 toward the other rail. In similar embodiments, such as FIG. 3A, the “lip” 300, and hence the “J” shape, is formed by curvature of the horizontal section 306, while in other embodiments the lip 300 is formed by a separate lip segment 300 that extends at right angles to the horizontal segment, as shown in FIG. 3C. In still other embodiments, the rails do not include a lip 300 and are “L” shaped, as shown in FIG. 3D.

In the embodiment of FIG. 2A, the rails 200 comprise separate upper 200a and lower 200b rails, while in the embodiment of FIG. 2B, the rails 200 are combined into a channel 202 having a rear section 204 fixed to the RV 100. In this embodiment, the rear section 204 functions as the vertical section for both of the rails 200, and the width of the rear section determines the rail-separating gap d.

With reference to FIG. 2C, the present invention further includes a normally flat, flexible elastic panel 206 having a width w that is greater than the spaced-apart distance d between the rails.

With reference to FIG. 2D, the disclosed invention also includes a flat, rigid or semi-rigid awning panel 208. In embodiments, the awning panel is a plastic panel, which can be tinted to block visible light and/or ultraviolet light from the sun.

With reference to FIG. 3A, the flexible panel 206 can be installed between the rails 200 by flexing the upper and lower edges of the flexible panel 206 toward each other, thereby forming the flexible panel 206 into a curved shape, and inserting the upper and lower edges of the flexible panel between the rails 200, as shown in the drawing, whereupon the upper and lower edges of the flexible panel 206 are pressed outward against the rails 200a, 200b, simultaneously maintaining the curved shape of the flexible panel 206 and retaining the flexible panel 206 between the rails 200, and in the illustrated embodiment, also due to the inward extending lip 300 that is provided by the “J” shaped rails 200a, 200b.

In various embodiments, w is approximately 50% greater than d, so that when the flexible panel 206 is installed between the rails 200, the flexible panel 206 extends outward from the RV by a distance of approximately one half of d.

In the embodiment of FIG. 3A, an upper edge of the awning panel 208 has been inserted between the upper edge of the flexible panel 206 and the upper rail 200a, so that the edge of the awning panel 208 is held in place by friction. The awning panel 208 is thereby caused to extend outward from the upper rail 200a, and to rest against the curve of the flexed panel 206, so that it extends at an oblique angle away from the wall of the RV 100 and in front of the window 102, thereby serving as an awning.

With reference to FIG. 3B, embodiments further include a spacer 302 that can be inserted between the panels 206, 208 to adjust the oblique angle at which the awning panel 208 extends outward, for example as the angle of the sun changes during the course of a day. In the illustrated embodiment, the spacer 302 is cylindrical in shape and somewhat elastic, so that it is slightly compressed between the panels 206, 208, thereby increasing the surfaces of contact therebetween and improving the frictional retention of the spacer 302. In various embodiments, the spacer 302 can take on other shapes in cross-section, such as wedge shaped, and need not extend across the entire lengths of the panels 206, 208.

Embodiments include a plurality of spacers 302 of differing size and/or shape to enable a wider range of adjustment of the awning angle. Among other advantages, the use of a spacer 302 reduces the degree to which the flexible panel 206 must be flexed, i.e. the required curvatures of the flexible panel 206, thereby allowing a stiffer and stronger material to be used for the flexible panel 206 and reducing material fatigue of the flexible panel 206.

With reference to FIG. 3C, in some embodiments the flexible panel 206 and the awning panel 208 are permanently joined at their upper edges. For some applications, this approach can provide a more secure anchoring of the awning panel 208 to the RV 100. In some of these embodiments, upon removal of the flexible panel 206 from the rails 200, it naturally flattens itself against the awning panel 208. In the illustrated embodiment, the panels 206, 208 are formed from the same sheet of plastic material by bending, and represent two different regions of the same monolithic article.

It will also be noted that in the embodiment of FIG. 3C, the rails 200 are “L” shaped rather than “J” shaped. Furthermore, it will be noted that, in embodiments, the “horizontal” sections 306 of the rails are not perpendicular to the vertical sections 304. For example, in the illustrated embodiment the outwardly extending “horizontal” portions 306 of the rails 200 are inclined slightly toward each other, which improves the retention of the flexible panel 206 between the rails 200.

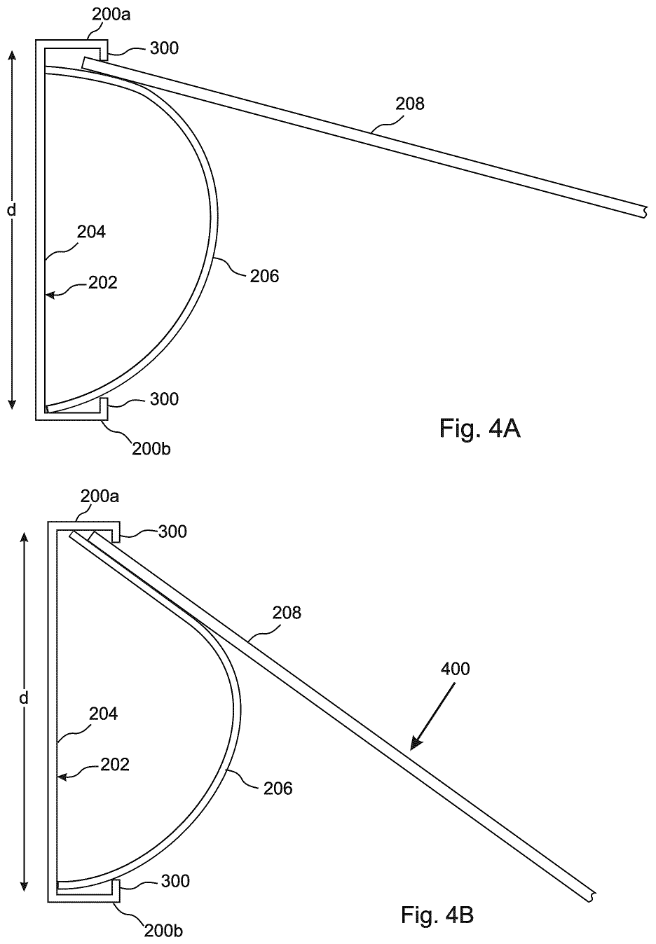

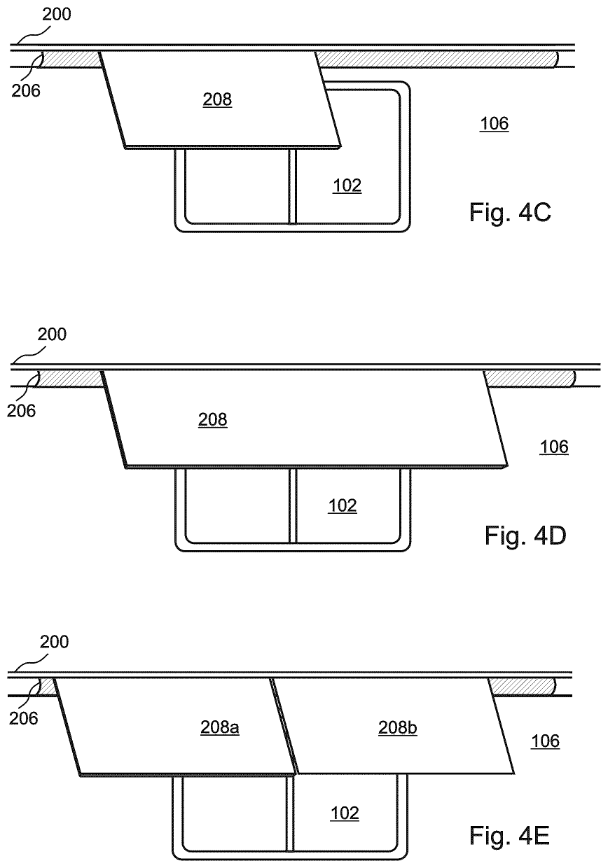

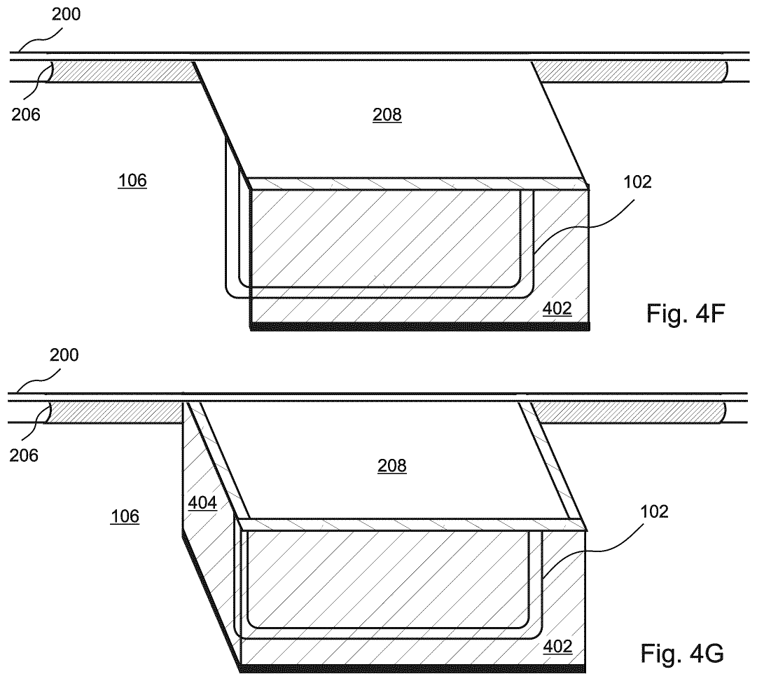

Comparing FIGS. 4A and 4B, it can be seen that the flexible panel 206 functions as a bow spring that enables the awning panel 208 to respond flexibly to gusts of wind 400 and/or to impinging rain. If, during use, the disclosed awning panel 208 is subjected to a very strong wind, the awning panel 208 in this embodiment will simply be dislodged from between the rails 200, and will fall to the ground, possibly together with the flexible panel 206, for later retrieval, without damage to the RV 100, and typically without damage to the awning panel 208 or the flexible panel 206.

With reference to FIGS. 4C-4E, in embodiments the rails 200 and flexible panel 206 are significantly wider than the window 102, and extend to either side thereof. With reference to FIG. 4C, if sunlight is shining on the side 106 of the RV 100 at an angle, the sunlight can be prevented from impinging on the window 102 by offsetting the awning panel 208 toward the sun. With reference to FIG. 4D, in some embodiments the awning panel 208 is much wider than the window 102, so that it will prevent the sun from impinging on the window at an angle, even when the awning panel 208 is centered above the window 102. With reference to FIG. 4E, in various embodiments a plurality of awning panels 208a, 208b are provided, which can be used singly, if the sun is directly above and in front of the window 102, or installed simultaneously, side-by-side above the window 102, to block sunlight that is approaching the window 102 at an angle.

With reference to FIG. 4F, embodiments include an opaque or translucent lightweight front shade panel 402 which can be suspended from the front edge of the awning panel 208, so that it blocks or dims the sunlight when the sun is near the horizon in front of the window 102. With reference to FIG. 4G, embodiments further include one or two side shade panels 404 that can be suspended from one or both sides of the awning panel to block or dim sunlight when the sun is near the horizon and off to one side of the window 102.

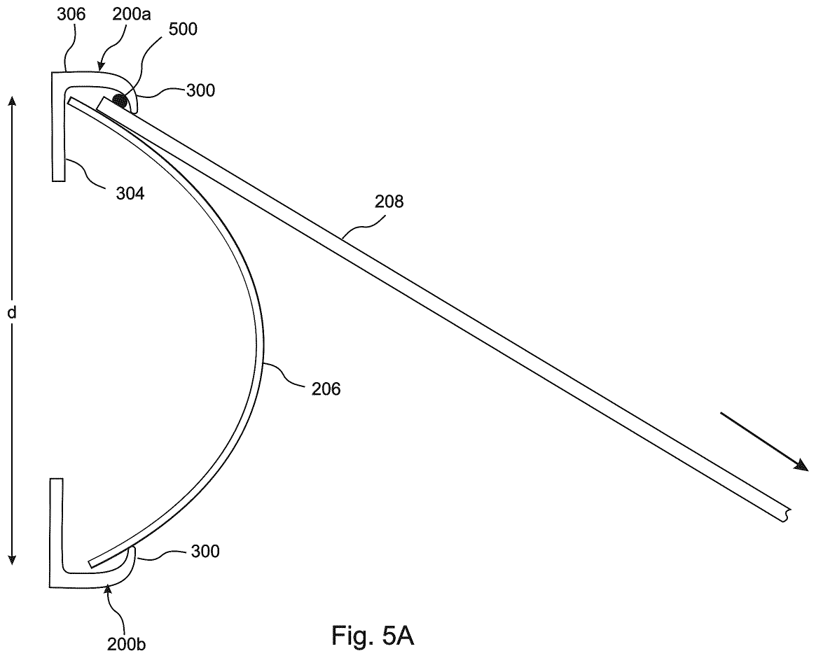

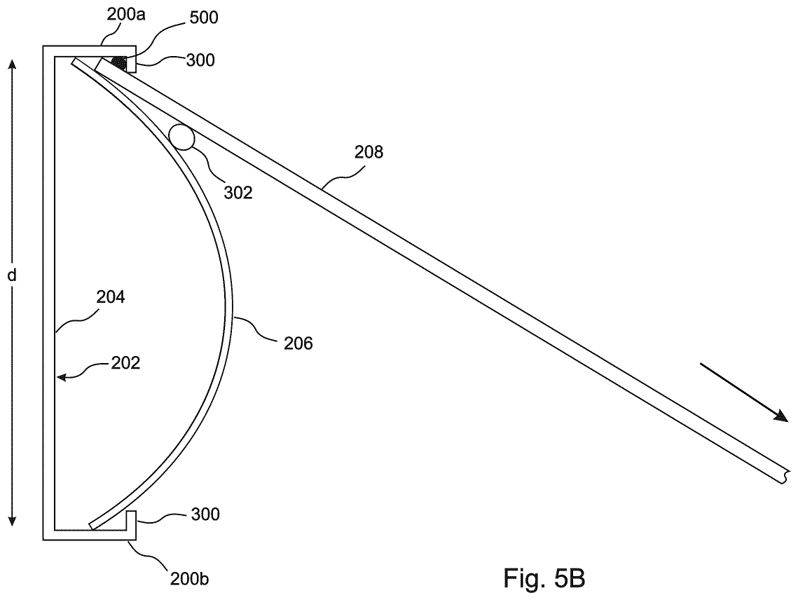

In the embodiments of FIGS. 3A-4G, the awning panel 208 is held in place entirely by friction. With reference to FIGS. 5A and 5B, in other embodiments that include “J” shaped rails 200a, retention of the awning panel 208 is enhanced by providing a retention bead 500 along the upper edge of the awning panel 208. FIGS. 5A and 5B are configured similarly to FIGS. 3A and 3B, respectively, except that they also include a retention bead 500.

Embodiments that include a retention bead 500 do not depend entirely on friction for retention of the awning panel 208. In fact, in some of these embodiments, friction plays only a minor role, if any, in the retention of the awning panel 208. As a result, the awning panel 208 is less likely to be dislodged due to a minor breeze, or other impact, although it will still be dislodged if sufficient force is applied, thereby protecting the RV wall 106 from damage.

Also, this approach enables a wider range of materials to be employed for the flexible panel 206. Instead of being limited to a materials that do not fatigue, and that maintain a strong enough tension when curved to provide sufficient frictional retention of the awning panel 208 under a wide variety of environmental conditions, the flexible panel 206 can be made from any material that can be formed into a curved shape that supports the awning panel 208 and can absorb downward loads 400. The bead makes panel retention less reliant on the friction generated by the flex piece squeezing the panel. For embodiments that include a retention bead 500, even if the friction force decreases for any reason, the awning panel 208 will not slide past the lip 300 of the rail 208a.

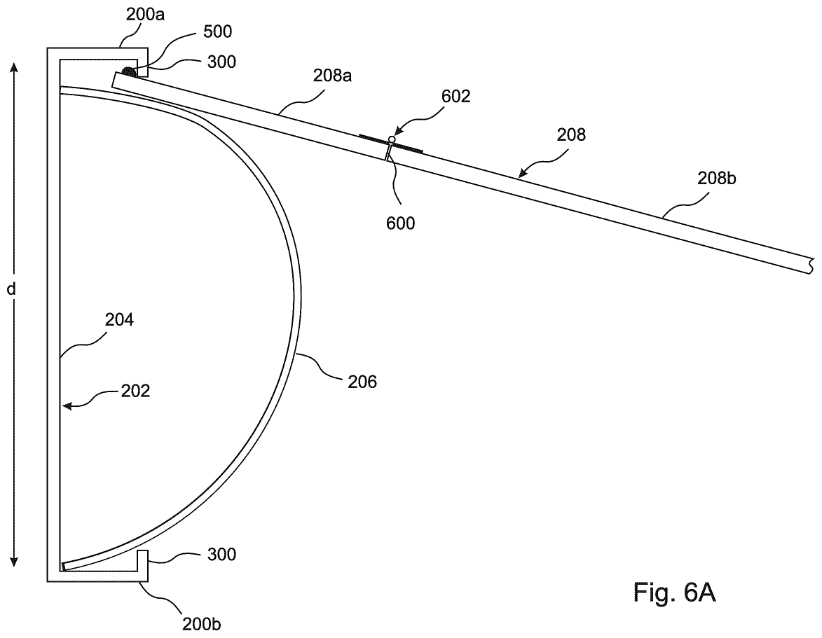

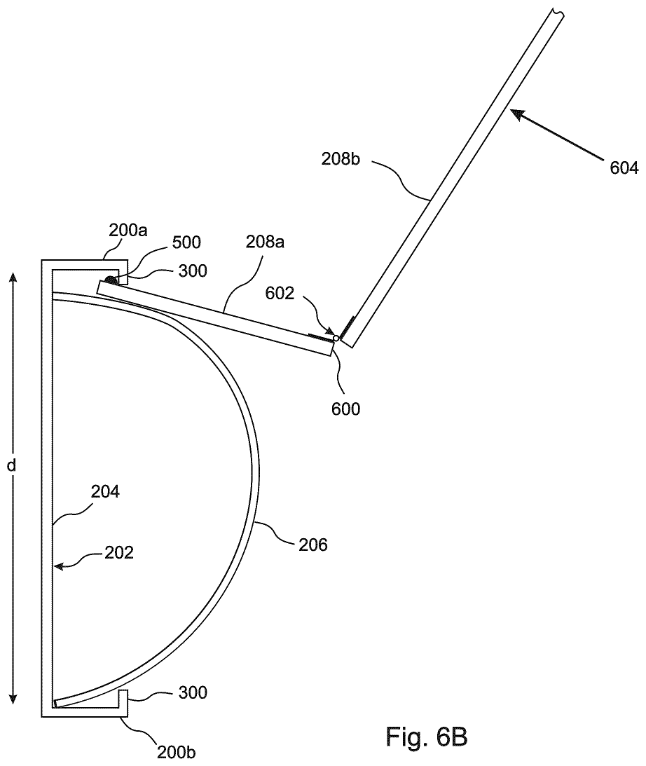

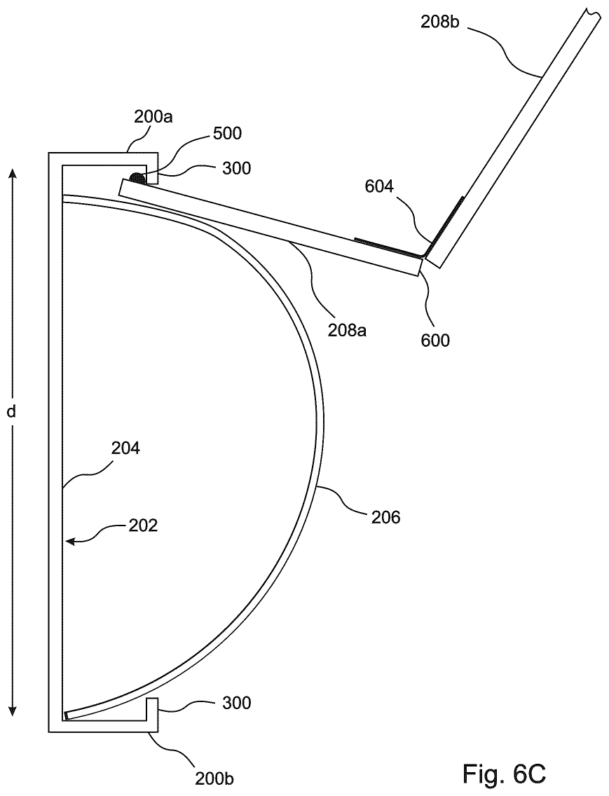

With reference to FIG. 6A, in embodiments the awning panel 208 is split into upper 208a and lower 208b panel segments that are connected together by one or more hinges 602. With reference to FIG. 6B, this arrangement enables the lower panel segment 208b, which includes a majority of the awning panel 208, to pivot upward about the hinge or hinges 602 when subjected to an updraft 604, for example caused by wind impinging on the side of the RV 100 below the awning panel 208. By allowing most of the awning panel 208b to rotate upward, attachment of the upper panel segment 208a maintains its orientation, such that the upper edge of the upper panel segment 208a is not levered away from the flexible panel 206 and the upper rail 200a.

In some of these embodiments, the awning panel segments 208a, 208b are made from a light, relatively thick sheet, such as from plastic-fluted, corrugated cardboard, so that the thickness of the panel segments 208a, 208b causes their adjoining edges 600 to abut against each other, and prevents the lower panel segment 208b from pivoting downward from the upper panel segment 208a.

In the embodiments of FIGS. 6A and 6B, the awning panel hinges 604 are conventional hinge-pin hinges. In the embodiment of FIG. 6C, the awning panel hinge 604 is a living hinge. In various embodiments, a living hinge 604 joining the two panel segments 208a, 208b is formed by a strip of adhesive tape, such as “duct” tape.

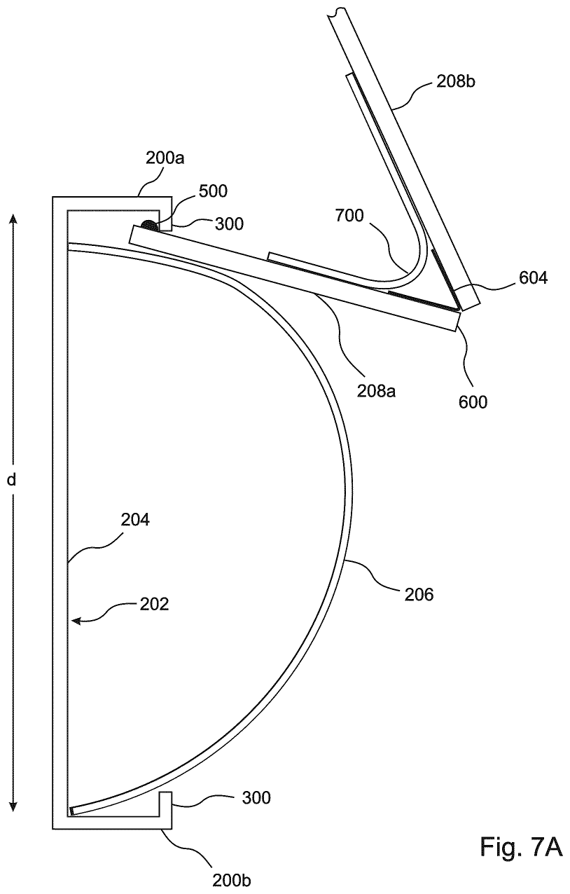

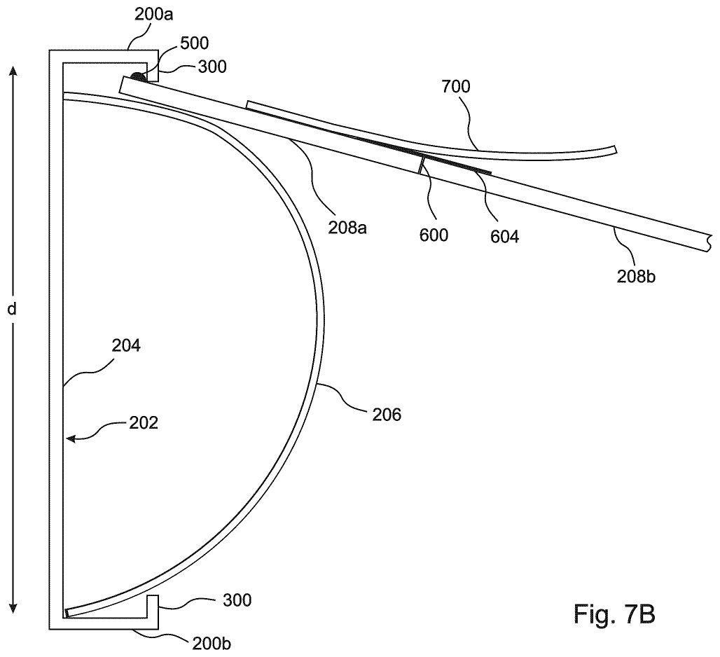

With reference to FIG. 7A, some embodiments that include an awning panel hinge 604 also include a hinge return spring 700, which can be a conventional coil spring incorporated as part of a hinge-pin hinge 604,, or a cantilever spring 700 as shown in FIGS. 7A and 7B. As illustrated in FIG. 7B, the hinge return spring 700 causes the lower panel segment 208b to return to its extended position after being lifted up, for example by a gust of wind 604. In embodiments, the spring tension of the hinge return spring 700 is strong enough to return the lower panel segment 208b to alignment with the upper panel segment 208a once a gust of wind 604 has passed, while being sufficiently weak to avoid dislodging the upper panel segment 208a from the rails 200 and flexible panel 206 when the lower panel segment 208b is lifted away from alignment with the upper panel segment 208a.

In the embodiment of FIGS. 7A and 7B, one end of the cantilever spring 700 is attached to the upper panel segment 208a, for example by an adhesive, while the other end of the cantilever spring 700 rests against the lower panel segment 208b when the lower panel segment 208b is lifted, as shown in FIG. 7A, and pulls away from the lower panel segment 208b when the lower panel segment 208b returns to its extended configuration, as shown in FIG. 7B.

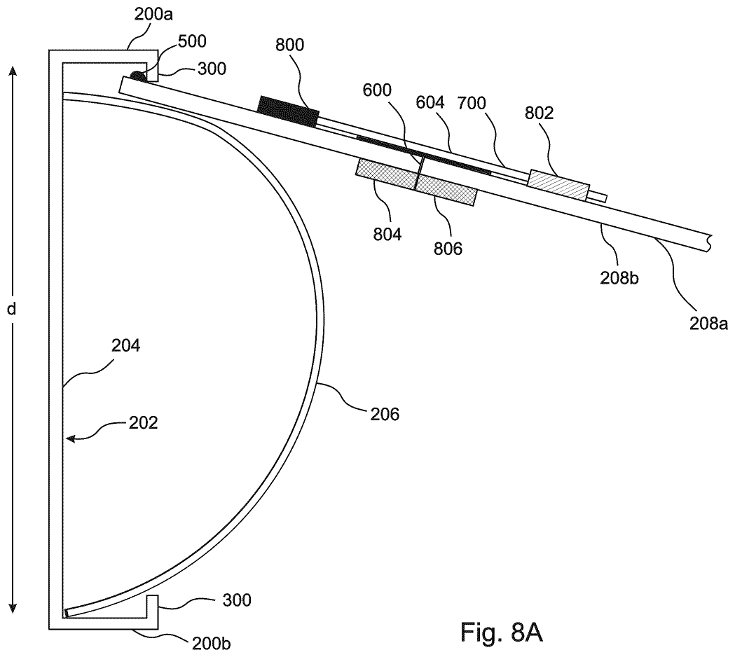

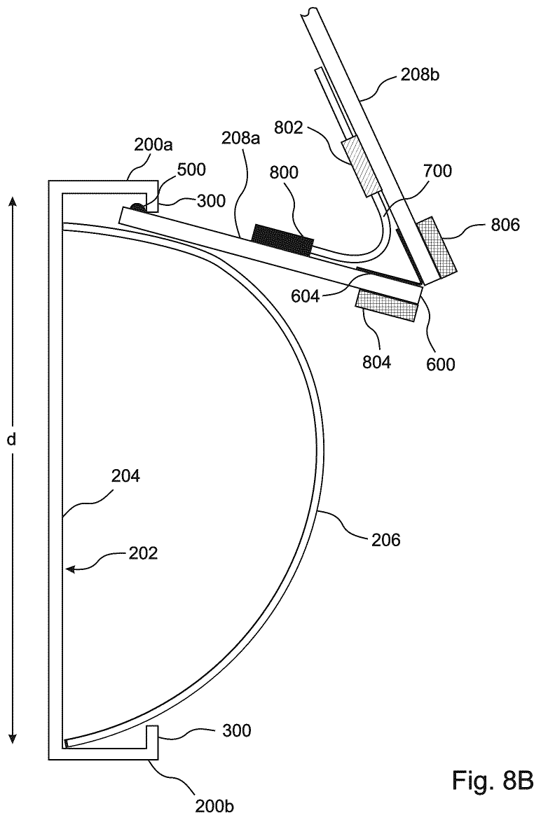

With reference to FIG. 8A, in similar embodiments the lower end of the cantilever spring 700 extends through a sleeve 802 provided in the lower panel segment 208b that allows the cantilever spring 700 to extend through the sleeve 802 when the cantilever spring 700 is being flexed, as shown in FIG. 8B. In FIGS. 8A and 8B, the upper end of the cantilever spring 700 is fixed within a spring mount 800, rather than being directly fixed to the upper panel segment 208a.

In some embodiments, such as FIGS. 7A and 7B, the upper 208a and lower 208b panel segments are sufficiently thick and rigid to enable the abutting panel edges 600 to maintain the panel segments 208a, 208b in alignment when they are not subjected to lifting forces 604. In other embodiments, the panel segments 208a, 208b may be too compressible and/or too thin to maintain this alignment, and may allow the lower panel segment 208b to “over-pivot,” i.e. to bend downward out of alignment with the upper panel segment 208a.

Accordingly, the embodiment of FIGS. 8A and 8B panel stops 804, 806 are attached to the lower faces of the panel segments 208a, 208b, and arranged so that they abut when the panel segments 208a, 208b are aligned, thereby preventing hyperextending. The panel stops 804, 806 can extend along the entire widths of the panel segments 208a, 208b, or can be located at one or more discrete locations along the widths of the panel segments 208a, 208b.

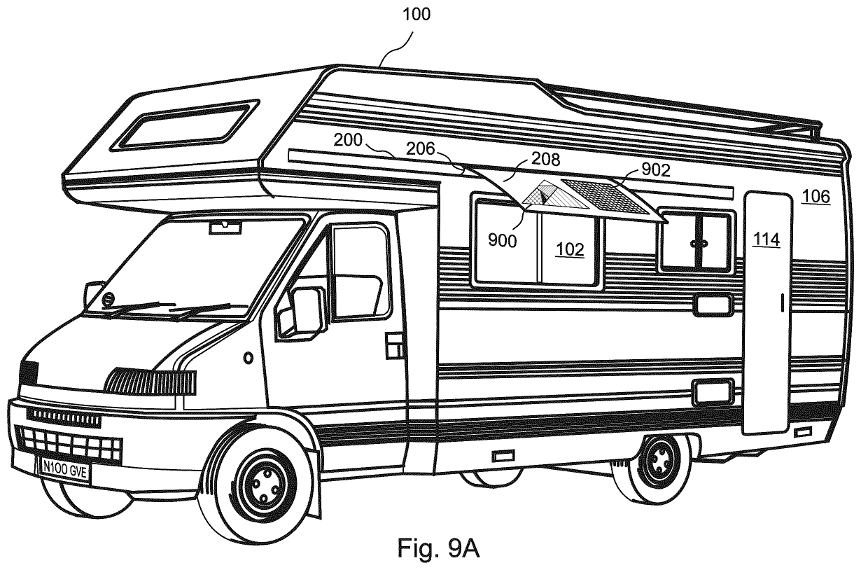

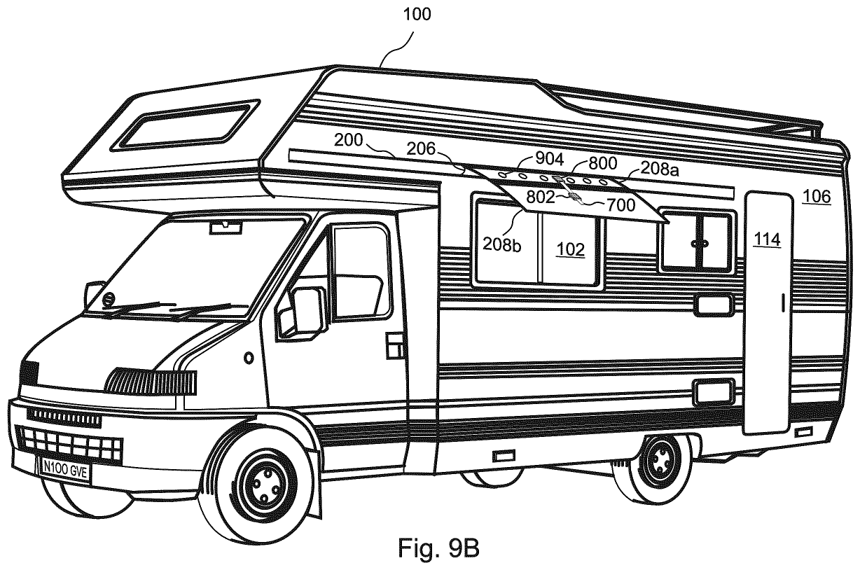

FIG. 9A illustrates an embodiment of the present invention installed on an RV with the awning panel 208 deployed. In the illustrated embodiment, the awning panel 208 is a plastic sheet that is monolithic, i.e. not divided into two hinged segments 208a, 208b. The awning panel 208 is slightly curved when installed, due to its flexibility, and because struts 110 are not included and not required. When not deployed, the awning panel 208 is flat.

The flexible panel 206 and awning panel 208 can be quickly and easily installed on the RV 100. According to one approach, the upper edge of the awning panel 208 is held up against the bottom edge of the top rail 200a and pushed lightly into the rail 200a, so that the entire upper edge of the awning panel 208 is in contact with the vertical section 304 of the rail 200a. If the awning panel 208 includes a retention bead 500, the bead 500 will be positioned behind the lip 300 of the rail 200a. Next the flexible panel 206 is bowed by hand. The top edge of the flexible panel 206 is installed first. The lower edge of the flexible panel 206 is then worked into the bottom rail 200b in a manner that maintains tension on its upper edge, while keeping the awning panel 208 in place until the bottom edge of the flexible panel 206 has been installed into the lower rail 200b.

When the RV 100 is to be moved, or for any other reason, the flexible panel 206 and awning panel 208 can be easily and quickly removed from between the rails 200. If a retention bead 500 is not included on the awning panel 208, both of the panels 206, 208 can simply be pulled away from the RV 100. If a retention bead 500 is included on the awning panel 208, removal of the awning panel 208 can require a slight compression of the flexible panel 206. Once the awning panel 208 has been removed, the flexible panel 206 can then be easily pulled away from the RV 100. Upon being removed from the RV 100, the panels 206, 208 revert to their naturally flat shapes. The two flat panels 206, 208 can then be easily stored in a convenient location within the RV 100, without adding significant weight to the vehicle.

Embodiments can include a plurality of exchangeable awning panels 208, for example to be used as spares, to be used under different weather conditions, to provide different awning widths, and to provide different degrees of transparency, different decorative colors and/or other features, etc. For example, the awning panel 208 of FIG. 9A includes decorative graphics 900 and solar panels 902. The solar panels 902 can be used to provide additional interior power. Because of the low weight and flat shape of the awning panels 208, there is very little weight/space penalty associated with maintaining additional awning panels 208.

FIG. 9B illustrates an embodiment of the present invention in which the awning panel 208 is divided into upper 208a and lower 208b panel segments joined by a living hinge 604 and maintained in a deployed configuration by a cantilever spring 700, as discussed above with reference to FIG. 8A and 8B. In the illustrated embodiment, “puck” lighting fixtures 904 are installed in the upper panel segment 208a.

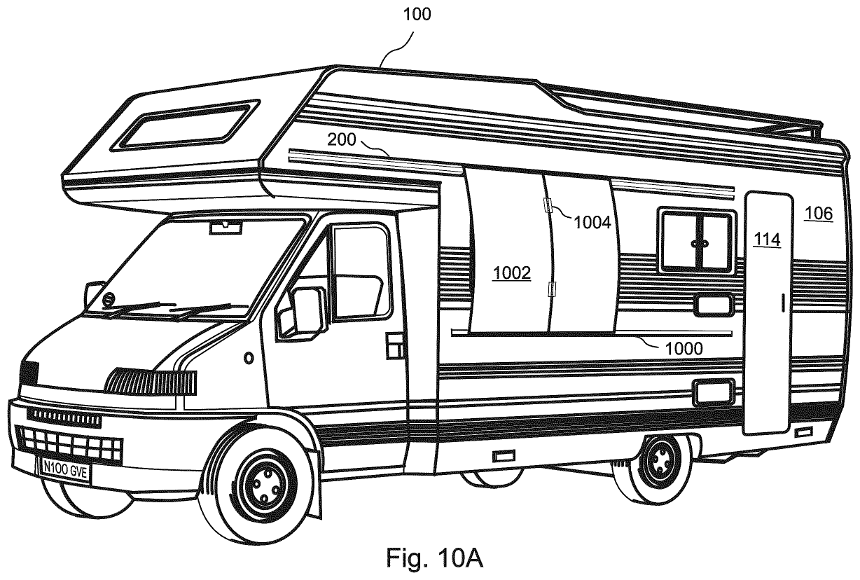

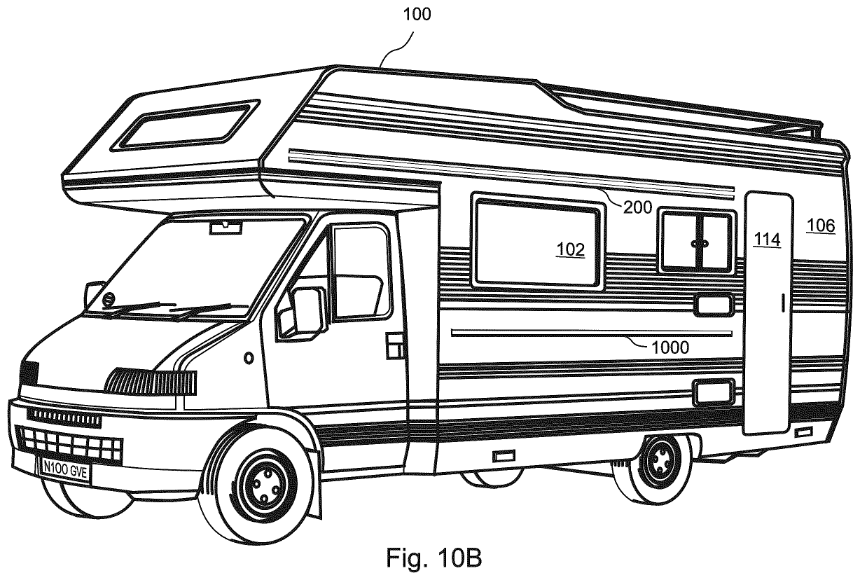

With reference to FIG. 10A, some embodiments further include a “third rail” 1000, which can be mounted below the window 102. The third rail 1000, which can be similar in design to the lower rail 200b, enables a larger window-covering panel 1002 to be installed between the upper rail 200a and the third rail 1000 to entirely cover the window 102. For example, a tinted panel 1002 can be installed as the window-covering panel 1002 to reduce glare when the window 102 is expose to too much sunlight, or an opaque window-covering panel 1002 can be installed over the window 102 for privacy or to darken the interior. Depending on the height of the window 102, in some embodiments the awning panel 208 can be installed between the upper rail 200a and the third rail 1000 as the window-covering panel. In the illustrated embodiment, the window-covering panel 1002 includes cover panel hinges 1004 that enable the panel 1002 to be folded to a smaller flat configuration for easier storage when not in use.

With reference to FIG. 10B, only the rails 200, 1000 remain mounted to the RV 100 when it is traveling, having virtually no impact on the aerodynamics of the RV 100. In embodiments, the rails 200, 1000 are wider than the window 102, thereby allowing the awning panel 208 and cover panel 1002 to be wider than the window 102. Embodiments enable the use of, and interchange between, awning panels 208 and cover panels 1000 of various widths, according to weather and solar conditions at any given time, including awning panels 208 that extend wider than the underlying window 102. In the illustrated embodiment, the rails 200, 1000 extend along large portions of the side of the RV 100, which causes the rails 200, 1000 to appear visually similar to RV “trim” that might be included for some other purpose, or for purely decorative effect.

In FIGS. 10A and 10B, the rails 200, 1000, are formed from separate upper 200a and lower 200b rails, as illustrated in FIG. 2A, rather than being combined into a channel 202, as shown in FIG. 2B. Providing separate upper and lower rails 200a, 200b, as illustrated in FIGS. 10A and 10B can be advantageous, in that the upper and lower rails 200a, 200b can be placed above and below features, such as fasteners, a seam, or existing molding, that may preclude installing a channel 202 in the same location. Separate upper and lower rails 200a, 200b can also be advantageous when the “vertical” wall 106 of the RV 100 is curved, rather than flat as depicted in the present figures, because it may be difficult or impossible for a long, wide channel 202 to be flush against a curved wall 106. On the other hand, the channel approach 202 of FIG. 2B necessarily provides a uniform spacing between the upper and lower rails 200a, 200b, which can be more difficult to achieve when separate upper and lower rails 200a, 200b are implemented.

The foregoing description of the embodiments of the invention has been presented for the purposes of illustration and description. Each and every page of this submission, and all contents thereon, however characterized, identified, or numbered, is considered a substantive part of this application for all purposes, irrespective of form or placement within the application. This specification is not intended to be exhaustive or to limit the invention to the precise form disclosed. Many modifications and variations are possible in light of this disclosure.

Although the present application is shown in a limited number of forms, the scope of the disclosure is not limited to just these forms, but is amenable to various changes and modifications. The present application does not explicitly recite all possible combinations of features that fall within the scope of the disclosure. The features disclosed herein for the various embodiments can generally be interchanged and combined into any combinations that are not self-contradictory without departing from the scope of the disclosure. In particular, the limitations presented in dependent claims below can be combined with their corresponding independent claims in any number and in any order without departing from the scope of this disclosure, unless the dependent claims are logically incompatible with each other.

What is claimed is:

1. An awning system for a recreational vehicle (RV) comprising:
an upper rail and a lower rail, each of the upper and lower rails being configured for horizontal mounting thereof to an exterior, substantially vertical wall of the RV, each of the upper and lower rails comprising, in cross section, a vertical section configured for mounting against the vertical wall of the RV, and a horizontal section configured for extending out substantially horizontally from the vertical section away from the vertical wall of the RV, the upper and lower rails being mountable above a window or door of the RV with the upper rail being above the lower rail in a vertically aligned configuration in which the horizontal sections are vertically separated from each other by a rail separating gap;
a substantially rectangular, flat, flexible panel having upper and lower edges separated by a flexible panel width that is greater than the rail-separating gap, the flexible panel being bendable about a longitudinal axis thereof, thereby forming a curved flexible panel, the upper and lower edges of the curved flexible panel being insertable between the horizontal sections of the upper and lower rails, so that a central portion of the curved flexible panel extends outward from the vertical wall of the RV, elasticity of the curved flexible panel causing the upper and lower edges of the curved flexible panel to press outwardly against the horizontal sections of the upper and lower rails; and
an awning panel having an upper awning edge that can be positioned between the horizontal section of the upper rail and the upper edge of the curved flexible panel, thereby fixing the upper awning edge proximate the vertical wall of the RV while a remainder of the awning panel extends away from the vertical wall of the RV at an oblique angle above the window or door, and is supported by the curved central portion of the flexible panel.

2. The awning system of claim 1, wherein the awning system is configured for fixing of the upper awning edge proximate the vertical wall of the RV due entirely to friction between the flexible panel, the awning panel, and the upper rail.

3. The awning system of claim 1, wherein the upper rail includes a lip section that extends vertically downward from a distal edge of the horizontal section that is furthest from the vertical wall of the RV, the upper rail thereby having a “J” shape in cross section.

4. The awning system of claim 3, wherein the awning panel further comprises a retention bead extending horizontally proximate the upper awning edge and configured for enhancing the fixing of the upper awning edge proximate the vertical wall of the RV due to contact between the retention bead and the lip section of the upper rail.

5. The awning system of claim 1, further comprising a spacer configured for insertion between the flexible panel and the awning panel proximate the upper rail, thereby adjusting the oblique angle of the awning panel.

6. The awning system of claim 1, wherein the awning panel comprises an upper panel segment and a lower panel segment, the upper and lower panel segments being joined together by an awning hinge that is configured to allow the lower panel segment to pivot upward about the awning hinge while the upper panel segment remains fixed at the oblique angle proximate the vertical wall of the RV.

7. The awning system of claim 6, wherein the awning hinge is a living hinge.

8. The awning system of claim 6, further comprising a hinge return spring cooperative with the awning hinge and configured to return the lower panel segment into alignment with the upper panel segment.

9. The awning system of claim 8, wherein the awning hinge is a living hinge, and wherein the hinge return spring is a cantilever spring having an upper end fixed to the upper panel segment, and a lower end configured to press against the lower panel segment when the lower panel segment is pivoted upward about the awning hinge.

10. The awning system of claim 9, wherein the lower end of the cantilever spring extends through a sleeve that is fixed to the lower panel segment.

11. The awning system of claim 6, further comprising upper and lower panel stops affixed respectively to lower sides of the upper and lower panel segments and substantially aligned with abutting edges thereof, the upper and lower panel stops being thereby configured to inhibit rotation of the lower panel segment downwardly out of alignment with the upper panel segment.

12. The awning system of claim 1, further comprising:
a third rail configured for horizontal mounting thereof to the vertical wall of the RV below the window or door of the RV, the third rail comprising, in cross section, a vertical section configured for mounting against the vertical wall of the RV and a horizontal section configured for extending out substantially horizontally from the vertical section away from the vertical wall of the RV; and
a covering panel having upper and lower covering edges that can be installed between one of the upper and lower rails and the third rails such that the covering panel is flexed and bows distally away from the vertical wall of the RV, thereby causing the covering panel to cover the window or door of the RV.

13. The awning system of claim 12, wherein the covering panel is tinted or opaque, thereby reducing or preventing penetration therethrough of at least one of visible light and ultra-violet light.

14. The awning system of claim 1, further comprising at least one of a decorative graphic, a solar panel, and a lighting fixture applied to the awning panel.

15. The awning system of claim 1, further comprising at least one shade panel attached to and extending vertically down from a front edge or a side edge of the awning panel.

16. The awning system of claim 1, wherein the upper and lower rails extend laterally beyond at least one side of the window or door of the RV, thereby enabling the awning panel to be wider than the window or door of the RV, and/or to be suspended in a location that is not vertically aligned with the window or door of the RV.

17. A method of shielding a window or door provided in a substantially vertical wall of a recreational vehicle (RV) from at least one of sunlight and rain, the method comprising:
providing an awning system according to claim 1;
mounting the upper and lower rails above the window or door of the RV with the upper rail being above the lower rail in the vertically aligned configuration in which the horizontal sections are vertically separated from each other by the rail separating gap;
bending the flat, flexible panel about its longitudinal axis, thereby forming it as a curved flexible panel;
inserting the upper and lower edges of the flexible panel between the horizontal sections of the upper and lower rails, a central portion of the curved flexible panel extending outward from the vertical wall of the RV, so that the elasticity of the curved flexible panel causes the upper and lower edges of the curved flexible panel to press outwardly against the horizontal sections of the upper and lower rails, thereby maintaining the upper and lower edges of the curved flexible panel proximate the vertical wall of the RV; and
positioning the upper awning edge between the horizontal section of the upper rail and the upper edge of the curved flexible panel, thereby fixing the upper awning edge proximate the wall of the RV while a remainder of the awning panel extends away from the wall of the RV and is supported by the curved central portion of the curved flexible panel, such that the awning panel extends at the oblique angle away from the RV over the window or door.

18. The method of claim 17, wherein mounting the upper and lower rails above the window or door of the RV includes forming a watertight seal between the upper rail and the vertical wall of the RV.

19. The method of claim 17, wherein the awning system further includes a spacer and wherein the method further includes inserting the spacer between the awning panel and the flexible panel proximate the upper rail, thereby adjusting the oblique angle of the awning panel.

20. The method of claim 17, wherein the method further includes detaching both the curved flexible panel and the awning panel from the vertical wall of the RV, whereupon both the curved flexible panel and the awning panel return naturally to a substantially flat configuration.
